(19) United States
(12) Patent Application Publication
(10) Pub. No.: US 2013/0180658 A1
(43) Pub. Date: Jul. 18, 2013

(54) TILT CORRECTING APPARATUS AND BONDING METHOD USING THE SAME

(71) Applicants: Hyun Pyo SHIN, Gyunggi-do (KR); Jeung Be MOON, Gyunggi-do (KR); Seung Hee CHO, (US)

(72) Inventors: Hyun Pyo SHIN, Gyunggi-do (KR); Jeung Be MOON, Gyunggi-do (KR); Seung Hee CHO, (US)

(73) Assignee: SAMSUNG ELECTRO-MECHANICS CO., LTD., Gyunggi-do (KR)

(21) Appl. No.: 13/441,135

(22) Filed: Apr. 6, 2012

(30) Foreign Application Priority Data
Jan. 12, 2012 (KR) 10-2012-0003885

(51) Int. Cl. B32B 38/18; B32B 37/12; B32B 37/14; B32B 37/10

(52) U.S. Cl. 156/297; 156/538

(57) ABSTRACT

Disclosed herein is a tilt correcting apparatus including: a bracket part forming an appearance frame; an operating part disposed under the bracket part; a housing part vertically moved by the operating part and having a plurality of through holes mounted on a top surface thereof; and a plurality of elastic support part mounted in an inner space of the housing part and protruded through the through holes. The tilt correcting apparatus according to the preferred embodiments of the present invention can correct the tilt of the PCB and the image sensors through a translation and rotation movement according to 6 degree of freedom, thereby bonding the PCB cells and the image sensors at a uniform interval by using the adhesive.

### CROSS REFERENCE TO RELATED APPLICATION

This application claims the benefit of Korean Patent Application No. 10-2012-0003885, filed on Jan. 12, 2012, entitled “Tilt Correcting Apparatus And Tilt Correcting Method Using The same”, which is hereby incorporated by reference in its entirety into this application.

### BACKGROUND OF THE INVENTION

1. Technical Field

The present invention relates to a tilt correcting apparatus and a bonding method using the same.

2. Description of the Related Art

As a market for a camera for a mobile phone has been rapidly grown and demands of a user has been increased, high resolution of the camera is essential. However, a method for bonding a printed circuit board to image sensors used for a current camera module for a mobile phone causes a tilt error between lenses and image sensors of about several tens of due to machining errors of raw materials and deformations according to hardening of an applied bond.

When the tilt error occurs, an image passing through a lens is out of focus in the image sensors and thus, is displayed as a blurring image.

In order to solve the tilt error, research into an improvement in position precision of bonding equipment, machining errors of raw materials and facilities, or the like, has been conducted. However, there is a limitation in lowering the tilt error by about several μm.

In particular, the prior art has performed a process of reducing a tilt error by a method of determining defects by observing images generated after a process of bonding a PCB to image sensors and then, attaching a lens housing is performed, as disclosed in KR Patent Laid-Open Publication No. 2011-0100000 (laid-open published on Sep. 9, 2011). In order to supplement this, a method according to the prior art that has been used to correct a tilt corresponds to a method for observing, aligning, and attaching images in real time at the time of aligning a lens housing and a lens on a top surface of the PCB.

However, in the case of the method, it takes a long time to align the lens housing and the lens, thereby degrading productivity. In order to overcome the problem, a need exists for a method for performing manufacturing using more equipment. However, when performing the manufacturing using many equipments, many labors may be required and maintenance time may be increased in proportion to the increased number of equipments.

### SUMMARY OF THE INVENTION

The present invention has been made in an effort to provide a tilt correcting apparatus automatically correcting a tilt occurring during a process of bonding a PCB to image sensors.

Further, the present invention has been made in an effort to provide a bonding method using a tilt correcting apparatus.

According to a preferred embodiment of the present invention, there is provided a tilt correcting apparatus, including: a bracket part forming an appearance frame; an operating part disposed under the bracket part; a housing part vertically moved by the operating part and having a plurality of through holes mounted on a top surface thereof; and a plurality of elastic support part mounted in an inner space of the housing part and protruded through the through holes.

The bracket part may extend upwardly at a right angle at left and right sides thereof based on a bottom surface thereof.

The tilt correcting apparatus may further include: left and right guide parts each mounted on both sides extending from the bracket part; and stopper parts each mounted on ends extending from the left and right of the bracket part, wherein the housing part contacts between the left and right guide parts.

The guide part may be mounted in a structure having a roller or a bearing mounted therein or in a slide type structure so that the housing part moves vertically.

The operating part may use a cylinder vertically moving the housing part by using oil pressure or air pressure.

The operating part may use an electromotive device vertically moving the housing by using a motor.

The elastic support part may include: a lower support body mounted at one side in the housing part; an upper support body protruded through the through hole; and an elastic body connecting between the upper support body and the lower support part.

The upper support body may include: a top end including a plurality of protruding teeth protruded through the through hole and mounted along an edge thereof; and a bottom end having a step having a bottom surface supported by the elastic body and hung to the through hole.

The top end may be protruded, having tolerance from the through hole, and the upper support part may be operated, having six degrees of freedom due to the tolerance and the elastic body.

The elastic body may use any one of a coil spring, a hydraulic spring, and a pneumatic spring.

According to another preferred embodiment of the present invention, there is provided a bonding method using a tilt correcting apparatus, including: applying an adhesive to top surfaces of each cell formed on a PCB and then, disposing the PCB on a top of the tilt correcting apparatus; allowing an elastic support part of the housing part to elastically support bottom surfaces of each cell by lifting the housing part of the tilt correcting apparatus upwardly; and picking up electronic devices so as to be disposed corresponding to the adhesive of the cells and pressing the electronic devices.

At the disposing of the PCB on the tilt correcting apparatus, the PCB may be disposed on the top of the tilt correcting apparatus by using a transfer rail.

At the elastically supporting, the elastic support part may include: a lower support body mounted at one side in the housing part; an upper support body protruded through the through hole; and an elastic body connecting between the upper support body and the lower support body, and the upper support body includes: a top end including a plurality of protruding teeth protruded through a plurality of through holes formed on a top surface of the housing part and contacting the bottom surfaces of the cells along an edge thereof; and a bottom end having a step having a bottom surface supported by the elastic body and hung to the through hole.

The top end is protruded, having tolerance for the through hole, and the upper support body may correct a tilt between the cells and image sensors, having six degrees of freedom due to the tolerance and the elastic body.

At the pressing, the electronic device may include image sensors and a head of bonding equipment may pick up and press the image sensors.

### BRIEF DESCRIPTION OF THE DRAWINGS

FIG. 1 is an exploded perspective view of a tilt correcting apparatus according to a preferred embodiment of the present invention.

FIG. 2 is a perspective view of the tilt correcting apparatus according to the preferred embodiment of the present invention.

FIG. 3 is a front perspective view of the tilt correcting apparatus according to the preferred embodiment of the present invention.

FIG. 4 is an exemplified diagram for explaining a tilt correcting method using the tilt correction apparatus according to the preferred embodiment of the present invention.

FIG. 5 is an exemplified diagram for explaining a bonding method using the tilt correction apparatus according to the preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features, and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. While terms such as “first,” “second,” etc., may be used to describe various components, such terms are used only to distinguish one component from another, and the components must not be limited to the above terms. Further, when it is determined that the detailed description of the known art related to the present invention may obscure the gist of the present invention, the detailed description thereof will be omitted.

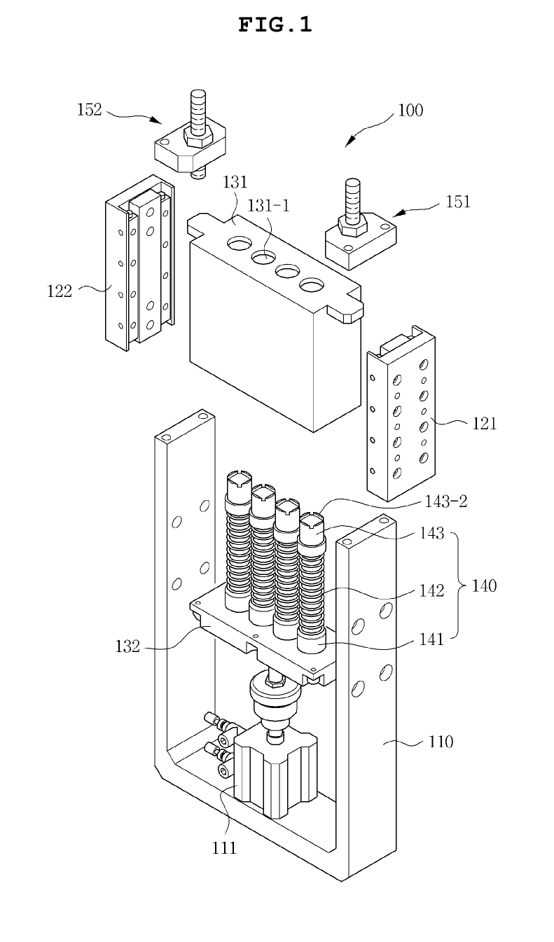

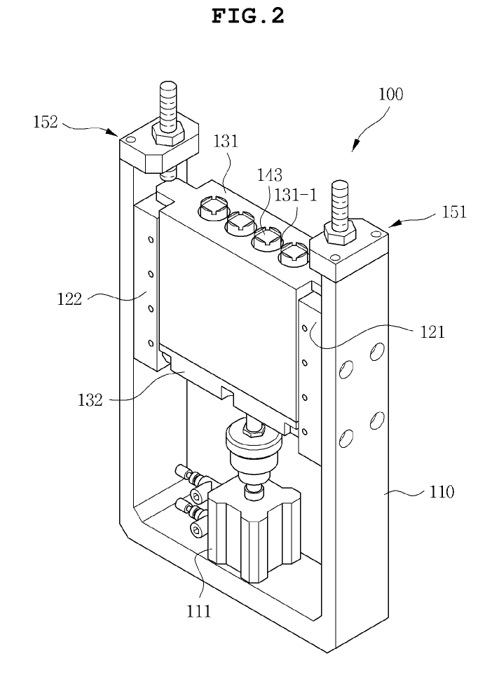

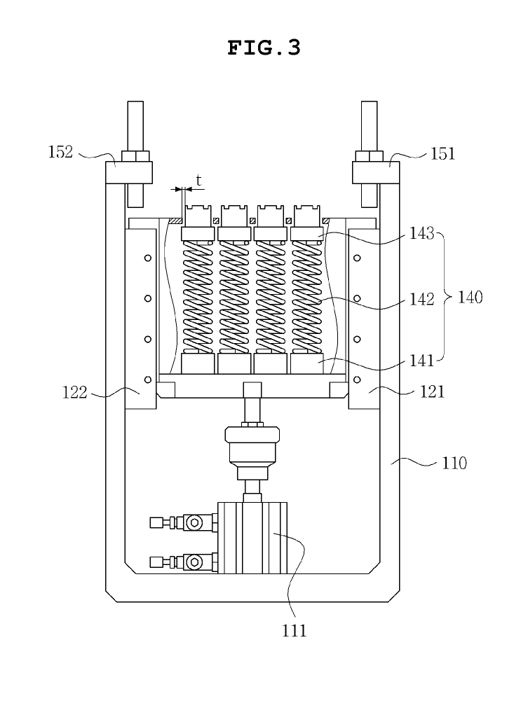

Hereinafter, preferred embodiments of the present invention will be described in detail with reference to the accompanying drawings. FIG. 1 is an exploded perspective view of a tilt correcting apparatus according to a preferred embodiment of the present invention, FIG. 2 is an exploded perspective view of the tilt correcting apparatus according to the preferred embodiment of the present invention, and FIG. 3 is a front perspective view of the tilt correcting apparatus according to the preferred embodiment of the present invention.

As a tilt correcting apparatus 100 according to the preferred embodiment of the present invention, a tilt correcting apparatus automatically correcting a tilt occurring during a process of bonding a PCB to image sensors will be described as an example. However, the tilt correcting apparatus 100 according to the preferred embodiment of the present invention is not limited thereto and may be applied to an apparatus of automatically correcting a tilt occurring during a process of bonding various components.

As shown in FIG. 1, the tilt correcting apparatus 100 according to the preferred embodiment of the present invention includes a bracket part 110, an operating part 111 mounted under the bracket part 110, left and right guide parts 121 and 122 mounted on both sides of the bracket part 110, respectively, housing parts 131 and 132 contacting between the left and right guide parts 121 and 122 and vertically moving by the operating part 111, elastic support parts 140 mounted in an inner space of the housing parts 131 and 132, and stopper parts 151 and 152 mounted at left and right top ends of the bracket part 110.

The bracket part 110 is a part forming a body appearance frame of the tilt correcting apparatus 100 using a metal material and has a “U”-letter section extending by being protruded upwardly at a right angle at both sides thereof based on a bottom surface thereof. The bracket part 110 forms the appearance frame of the tilt correcting apparatus 100 and is provided with a plurality of components.

The operating part 111, which is a part mounted on the bottom of the bracket part 110 and vertically moving while supporting a lower housing part 132, uses a cylinder vertically moving the lower housing part 132 by oil pressure or air pressure generated due to a fluid or air injected through a valve. Further, the operating part 111 may vertically move the lower housing part 132 by using an electromotive device such as a motor, or the like, instead of the cylinder using oil pressure or air pressure.

The left and right guide parts 121 and 122 each are fixedly mounted to correspond to each other at both extensions of the bracket part 110 and has a structure having, for example, a roller, a bearing, or the like, mounted therein or a slide type structure so that the housing parts 131 and 132 contacting therebetween move vertically.

The housing parts 131 and 132 are divided into an upper housing part 131 and a lower housing part 132 contacting between the left and right guide parts 121 and 122.

The upper housing part 131 includes the inner space including a plurality of elastic support parts 140 and the top surface thereof is provided with a plurality of through holes 131-1 through which upper support bodies 143 of the elastic support parts 140 are protruded. In this configuration, the through holes 131-1 are formed to have a size larger than that of the upper support body 143. As shown in FIG. 3, tolerance t is formed between the upper support bodies 143.

Further, the upper housing part 131 includes a stopper formed to be protruded to both sides of an end of the top surface thereof and the stopper contacts the stopper parts 151 and 152 during the vertically moving process of the housing parts 131 and 132 to stop the movement of the top of the housing parts 131 and 132.

The lower housing part 132 is mounted to be engaged with the bottom of the upper housing part 131 and is supported to vertically move by the operating part 111. The top surface of the lower housing part 132 is provided with a plurality of elastic support parts 140 and is mounted to be engaged with the bottom of the upper housing part 131.

The elastic support part 140 may be configured to include a lower support body 141 mounted on the top surface of the lower housing part 132, the upper support part 143 protruded through the through hole 131-1 of the upper housing part 131, and an elastic body 142 connecting between the upper support body 143 and the lower support body 141.

In detail, the lower support body 141, which is a part mounted on the top surface of the lower housing part 132 and coupled with the elastic body 142, may be formed in various shapes in addition to a cylindrical shape shown in FIG. 1 to support the elastic body 142.

One side of the elastic body 142 is connected with the lower support body 141 and the other side thereof is provided in a form supporting the bottom of the upper support body 143. The elastic body 142 serves as a member that generates an elastic movement of the upper support body 143.

Although the elastic body 142 is shown as a coil spring in FIG. 1, the elastic body 142 may use various elastic members having an elastic function such as a hydraulic spring, a pneumatic spring, or the like, without being limited.

As shown in FIG. 2, the upper support body 143 may be configured of a top end having a plurality of protruding teeth 143-2 protruded through the through hole 131-1 of the upper housing part 131 and mounted along edge thereof and a bottom end having a step having a bottom surface supported by the elastic body 142 and hung to the through hole 131-1. As shown in FIG. 1, although the top end of the upper support body 143 is shown in a cylindrical shape according to the shape of the through hole 131-1, the top end thereof may be provided in various shapes protruded through the through hole 131-1 without being limited.

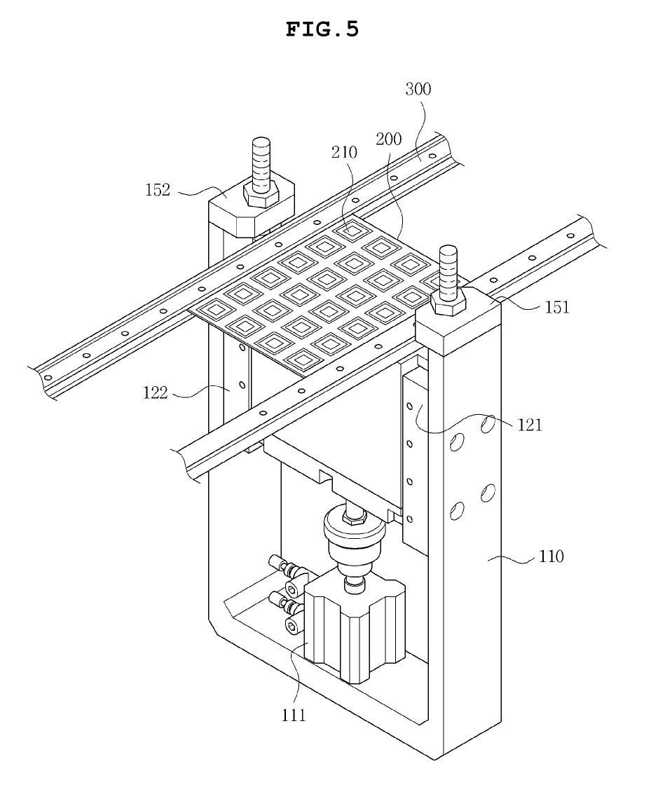

In particular, so as to support each cell formed on a PCB 200 to be described in connection with FIG. 5, the top end of the upper support body 143 may be provided so that the plurality of protruding teeth 143-2 are mounted along the edge to correspond to each other. The plurality of protruding teeth 143-2 may support each cell 210 formed on the PCB 200 by contacting the bottom surface thereof to each cell at a small area.

In this case, during a process of allowing a bonding head to press and bond the image sensors to each cell 210 formed on the PCB 200 at the top side thereof, the elastic body 142 and the upper support body 143 having the plurality of protruding teeth 143-2 corrects the tilt between each cell 210 formed on the PCB 200 and the image sensors.

In detail, the elastic body 142 serves to apply a uniform force between the cells 210 and the image sensors while reducing impact occurring during the pressing of the image sensors to each cell 210 formed on the PCB. Therefore, each cell 210 formed on the PCB and the image sensors may be bonded to one another at a uniform interval by an adhesive.

In this case, the plurality of protruding teeth 143-2 may bond the PCB to the image sensors by an adhesive by minimizing the influence of ruggedness occurring on the bottom surfaces of the cells 210 while supporting each cell 210 formed on the PCB 210.

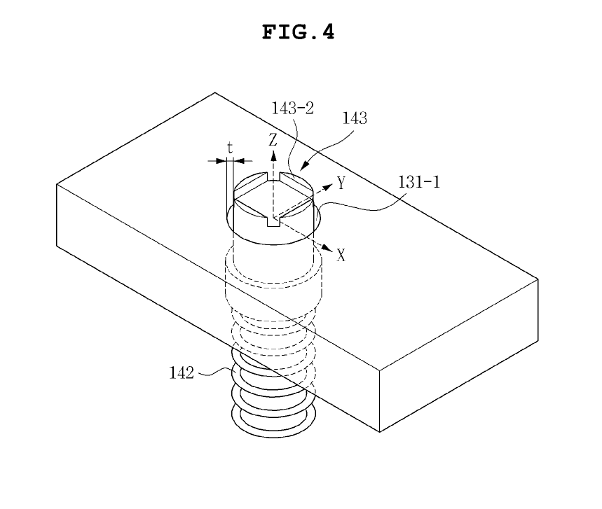

In addition, as shown in FIG. 4, the upper support body 143 is provided to have the tolerance t for the through hole 131-1, such that the upper support body 143 may be operated having six degrees of freedom due to the tolerance t.

The tolerance t between the support body 143 and the through hole 131-1 is formed to satisfy the following Equation.

$$t = \frac{D - d}{2} \qquad [ Equation 1 ]$$

(D: a diameter of the through hole 131-1, d: a diameter of the protruded upper support body 143).

In this case, the diameter D of the through hole 131-1 is associated with a maximum tilt angle θ and a thickness h of the upper housing part 131.

D=d cos θ+h sin θ [Equation 2]

(θ: a maximum tilt angle of the upper support body 143 based on the top surface (an X-Y plane of FIG. 4) of the upper housing part 131 formed with the through hole 131-1, h: a thickness of the upper housing part 131 formed with the through hole 131-1).

In this case, the maximum tilt angle θ of the upper support body 143 has a relation Equation and the upper support body 143 supports the PCB cells 210.

$$θ = {tan}^{- 1} ( \frac{e}{w} ) \qquad [ Equation 3 ]$$

(e: a height error of the PCB cell 210, W: a width of the PCB cell 210).

According to the relation Equations, the support body 143 may perform the translation and rotation movement according to the six degrees of freedom to support the PCB cells 210, having the tolerance t from the through hole 131-1.

Therefore, the upper support body 143 supports the PCB cells 210 while correcting the tilt of the PCB cells 210 through the translation and rotation movement according to the six degrees of freedom, such that the PCB cells 210 and the image sensors may be bonded to one another at a uniform interval by an adhesive.

Hereinafter, the bonding method using the tilt correcting apparatus according to the preferred embodiment of the present invention will be described with reference to FIG. 5. FIG. 5 is an exemplified diagram for explaining a bonding method using the tilt correction apparatus according to the preferred embodiment of the present invention.

The bonding method using the tilt correcting apparatus 100 according to the preferred embodiment of the present invention describes an example in which the upper image sensor is bonded to each cell 210 formed on the PCB 200. Further, the tilt correcting apparatus 100 according to the preferred embodiment of the present invention is not limited thereto and may be applied to a bonding method by automatically correcting a tilt occurring during a process of bonding various components.

As shown in FIG. 5, the tilt correcting apparatus 100 according to the preferred embodiment of the present invention applies an adhesive such as epoxy, or the like, to the top surface of each cell 210 formed on the PCB 200 and then, moves along the transfer rail 300 so as to dispose the PCB on the top part of the tilt correcting apparatus 100.

In this case, the tilt correcting apparatus 100 according to the preferred embodiment of the present invention moves in an upper direction of the operating part 111 to upwardly lift the elastic support part 140 together with the upper housing part 131, thereby elastically supporting each cell 210 formed on the PCB 200.

Simultaneously therewith, a head of a die bonding equipment picks up the image sensors (not shown) to dispose and press the image sensors corresponding to the cells 210 of the PCB 200 to which the epoxy is applied.

In this case, the adhesive such as epoxy is spread by the pressure pressed by the head and the elastic support force of the elastic support part 140 on the top surface of the cells 210 to have uniform flatness and is rapidly cured at high temperature, thereby bonding the image sensors to the cells 210.

In particular, as shown in FIG. 4, the upper support body 143 supports the PCB cells 210 while correcting the tilt of the PCB cells 210 through the translation and rotation movement according to the six degrees of freedom, such that the PCB cells 210 and the image sensors may be bonded to one another at a uniform interval by an adhesive.

The PCB cells 201 and the image sensors are bonded to one another by the adhesive while correcting the tilt therebetween, such that the PCB cells 210 and the image sensors may be bonded to one another at a uniform thickness by the adhesive without the tilt.

In addition, a process of bonding the image sensors to the

PCB cells 210 in a transverse direction shown in FIG. 5 and then, bonding the image sensors 210 to the PCB cells 210 in another transverse direction using the tile correcting apparatus 100 according to the preferred embodiment of the present invention may be sequentially performed.

Therefore, a process of bonding the plurality of PCB cells 210 to the image sensors while moving the PCB 200 along the transfer rail 300 shown in FIG. 5 is sequentially performed, such that the bonding of the PCB cells 210 and the image sensors can be obtained in mass. Further, the bonding method using the tilt correcting apparatus 100 is applied to both of the cells formed over the PCB 200, thereby simultaneously performing the bonding of the image sensors.

Therefore, the high-resolution camera module with the reduced tilt error between the PCB cells 210 and the image sensors may be provided. In particular, the yield of the high-resolution camera module can be improved by the mass production.

In addition, the bonding method using the tilt correcting apparatus 100 according to the preferred embodiment of the present invention can higher productivity than the tilt error correcting technology according to the related art and reduce the number of equipments to be mounted therein, thereby saving the labor costs and the investment cost for equipment.

The tilt correcting apparatus according to the preferred embodiments of the present invention can correct the tilt of the PCB and the image sensors through a translation and rotation movement according to six degrees of freedom, thereby bonding the PCB cells to the image sensors at a uniform interval by an adhesive.

The bonding method using the tilt correcting apparatus according to the preferred embodiment of the present invention can mass produce the high-resolution camera module with the reduced tilt error between the PCB cells and the image sensors.

In addition, the bonding method using the tilt correcting apparatus according to the preferred embodiment of the present invention can higher productivity than the tilt error correcting technology according to the related art and reduce the number of equipments to be mounted therein, thereby saving the labor costs and the investment cost for equipment.

Although the preferred embodiments of the present invention have been disclosed for illustrative purposes, they are for specifically explaining the present invention and thus a tilt correcting apparatus and a bonding method using the same according to the present invention are not limited thereto, but those skilled in the art will appreciate that various modifications, additions and substitutions are possible, without departing from the scope and spirit of the invention as disclosed in the accompanying claims.

In addition, any and all modifications, variations or equivalent arrangements should be considered to be within the scope of the invention, and the detailed scope of the invention will be disclosed by the accompanying claims.

What is claimed is:

1. A tilt correcting apparatus, comprising:
a bracket part forming an appearance frame;
an operating part disposed under the bracket part;
a housing part vertically moved by the operating part and having a plurality of through holes mounted on a top surface thereof; and
a plurality of elastic support part mounted in an inner space of the housing part and protruded through the through holes.

2. The tilt correcting apparatus as set forth in claim 1, wherein the bracket part extends upwardly at a right angle at left and right sides thereof based on a bottom surface thereof.

3. The tilt correcting apparatus as set forth in claim 2, further comprising:
left and right guide parts each mounted on both sides extending from the bracket part; and
stopper parts each mounted on ends extending from the left and right of the bracket part,
wherein the housing part contacts between the left and right guide parts.

4. The tilt correcting apparatus as set forth in claim 3, wherein the guide part is mounted in a structure having a roller or a bearing mounted therein or in a slide type structure so that the housing part moves vertically.

5. The tilt correcting apparatus as set forth in claim 1, wherein the operating part uses a cylinder vertically moving the housing part by using oil pressure or air pressure.

6. The tilt correcting apparatus as set forth in claim 1, wherein the operating part uses an electromotive device vertically moving the housing by using a motor.

7. The tilt correcting apparatus as set forth in claim 1, wherein the elastic support part includes:
a lower support body mounted at one side in the housing part;
an upper support body protruded through the through hole; and
an elastic body connecting between the upper support body and the lower support part.

8. The tilt correcting apparatus as set forth in claim 7, wherein the upper support body includes:
a top end including a plurality of protruding teeth protruded through the through hole and mounted along an edge thereof; and
a bottom end having a step having a bottom surface supported by the elastic body and hung to the through hole.

9. The tilt correcting apparatus as set forth in claim 8, wherein the top end is protruded, having tolerance from the through hole, and
the upper support part is operated, having six degrees of freedom due to the tolerance and the elastic body.

10. The tilt correcting apparatus as set forth in claim 7. wherein the elastic body uses any one of a coil spring, a hydraulic spring, and a pneumatic spring.

11. A bonding method using a tilt correcting apparatus, comprising:
applying an adhesive to top surfaces of each cell formed on a PCB and then, disposing the PCB on a top of the tilt correcting apparatus;
allowing an elastic support part of the housing part to elastically support bottom surfaces of each the cell by lifting the housing part of the tilt correcting apparatus upwardly; and
picking up electronic devices so as to be disposed corresponding to the adhesive of the cells and pressing the electronic devices.

12. The bonding method as set forth in claim 11, wherein at the disposing of the PCB on the tilt correcting apparatus, the PCB is disposed on the top of the tilt correcting apparatus by using a transfer rail.

13. The bonding method as set forth in claim 11, wherein at the elastically supporting, the elastic support part includes:
a lower support body mounted at one side in the housing part;
an upper support body protruded through the through hole; and
an elastic body connecting between the upper support body and the lower support body, and
the upper support body includes:
a top end including a plurality of protruding teeth protruded through a plurality of through holes formed on a top surface of the housing part and contacting the bottom surfaces of the cells along an edge thereof; and
a bottom end having a step having a bottom surface supported by the elastic body and hung to the through hole.

14. The bonding method as set forth in claim 13, wherein the top end is protruded, having tolerance for the through hole, and
the upper support body corrects a tilt between the cells and image sensors, having six degrees of freedom due to the tolerance and the elastic body.

15. The bonding method as set forth in claim 11, wherein at the pressing, the electronic device includes image sensors and
a head of bonding equipment picks up and presses the image sensors.
